(19) United States
(12) Patent Application Publication
(10) Pub. No.: US 2026/0238640 A1
(43) Pub. Date: Aug. 13, 2026

(54) METHOD AND DEVICE FOR BUILDING DECENTRALIZED SECURE COMMUNICATION INFRASTRUCTURE NETWORK BASED ON BLOCKCHAIN AND DID TECHNOLOGY

(71) Applicant: BLOCKCHAIN LABS INC., Seoul (KR)

(72) Inventors: Yong Tae KIM, Seoul (KR); Byung Wan LIM, Seoul (KR); Jong Hoon PARK, Hanam-si (KR)

(73) Assignee: BLOCKCHAIN LABS INC., Seoul (KR)

(21) Appl. No.: 19/059,751

(22) Filed: Feb. 21, 2025

(30) Foreign Application Priority Data
Feb. 12, 2025 (KR) 10-2025-0017836

(51) Int. Cl. H04L 9/40; H04L 9/08; H04L 47/76; H04L 65/1073

(52) U.S. Cl. CPC H04L 63/0853; H04L 9/0825; H04L 47/76; H04L 65/1073

(57) ABSTRACT

The present disclosure relates to a personal web node corresponding to a first identifier. The personal web node includes a storage for storing data and at least one processor. The at least one processor is configured to transmit a data download request to a service provider corresponding to a second identifier, receive a data package including personal data and a data certificate from the service provider, wherein the data certificate includes the first identifier as information about an owner of the personal data, and a second electronic signature based on a second identifier for verifying a source of the personal data, verify the second electronic signature based on the second identifier and a blockchain network, extract the personal data from the data package, and store the personal data and the data certificate for the personal data into the storage.

### CROSS-REFERENCE TO RELATED APPLICATION

This application claims priority to Korean Patent Application No. 10-2025-0017836 filed on Feb. 12, 2025, and all the benefits accruing therefrom under 35 U.S.C. § 119, the contents of which are incorporated by reference in their entirety.

### BACKGROUND

The embodiments disclosed in the present disclosure relate to communication technology that provides call and messaging functions.

### SUMMARY

Conventional communication systems providing call and messaging functions are provided by a single service operator, and communication is performed through a centralized server managed by the service operator. Consequently, users' data is exposed to the service operator.

In conventional communication systems, users must use phone numbers issued by the service operator. Since one device must be mapped to one phone number, users are limited to using only one phone number based on one device. As a result, incidents and accidents due to illegal spam calls and spam messages to exposed phone numbers continue to occur.

To prevent exposure of users' data to service operators when using the communication system, the various embodiments disclosed in the present disclosure are intended to provide a communication system using end-to-end encryption between users that is not based on a centralized server managed by the service operator.

Furthermore, the present disclosure proposes a novel protocol that has not previously existed, which allows anyone to operate nodes supporting communication functions between users through a blockchain network, thereby enabling multiple entities to become service providers without being dependent on a single service operator.

The communication system disclosed in the present disclosure identifies users based on IDs on the blockchain network, and is intended to enable users to directly generate and manage multiple phone numbers to be used in the communication system.

According to an embodiment of the present disclosure, a communication method performed by a first user device corresponding to a first user DID, a second user device corresponding to a second user DID, and a blockchain network comprises retrieving, by the first user device, available messaging nodes through the blockchain network, and generating a first phone number having a prefix corresponding to a first messaging node among the available messaging nodes, obtaining, by the first user device, a first service endpoint of the first messaging node from the blockchain network based on the prefix, transmitting, by the first user device, a first phone number registration request to the first messaging node based on the first service endpoint, wherein the first phone number registration request includes the first user DID, a first electronic signature based on the first user DID, and type information of the first phone number, and wherein the first phone number type information is private, retrieving, by the first messaging node, first user status information from the blockchain network based on the first user DID, and generating a storage space corresponding to the first phone number, obtaining, by the second user device, the first service endpoint from the blockchain network based on the first phone number, transmitting, by the second user device, a join request for the first phone number to the first messaging node based on the first service endpoint, wherein the join request includes the second user DID and an electronic signature based on the second user DID, and retrieving, by the first messaging node, second user status information from the blockchain network based on the second user DID, and transmitting an approval notification to the second user device.

In addition, according to an embodiment of the present disclosure, a user device comprises a memory storing a user DID and at least one processor, and the at least one processor is configured to retrieve available messaging nodes through a blockchain network, generate a first phone number having a prefix corresponding to a first messaging node among the available messaging nodes, generate a first communication DID corresponding to the first phone number and a first communication private key and a first communication public key corresponding to the first communication DID, obtain a first service endpoint of the first messaging node from the blockchain network, transmit a first phone number registration request of a private 1:1 type to the first messaging node based on the first service endpoint, wherein the first phone number registration request includes an electronic signature based on the user DID and the first communication DID, receive a join notification for the first phone number from a second user device, wherein the join notification includes a second communication DID generated by the second user device, generate an encryption key based on the second communication DID and the first communication private key, and transmit an encrypted message with the encryption key to the first messaging node based on the encryption key.

According to the embodiments disclosed in the present disclosure, privacy regarding users' phone numbers can be ensured by providing a communication system that enables users to directly generate and manage their numbers.

Additionally, through phone numbers having private and public types, both communication methods same as existing communication systems and private communication methods can be provided.

By providing the communication system, which was previously provided by a single service provider, through a plurality of distributed messaging nodes, dependency on service providers can be reduced. Moreover, since communication is performed through end-to-end encryption, the service providing entity cannot have access to user data, thereby allowing users to maintain ownership of their data. Additionally, various effects that can be directly or indirectly understood through the present disclosure may be provided.

### BRIEF DESCRIPTION OF THE DRAWINGS

FIG. 1 is a diagram for generally explaining configuration and operation of a communication system according to an embodiment.

FIG. 2 is a diagram for explaining operations of a messaging node and a user device based on a private phone number according to an embodiment.

FIG. 3 is a signal flow diagram of a method for generating a 1:1 private phone number according to an embodiment.

FIG. 4 is a signal flow diagram of a messaging method based on a 1:1 private phone number according to an embodiment.

FIG. 5 is a signal flow diagram of a call method based on a 1:1 private phone number according to an embodiment.

FIG. 6 is a diagram for explaining operations of a messaging node and a user device based on a public phone number according to an embodiment.

FIG. 7 is a signal flow diagram of a method for generating a public phone number according to an embodiment.

FIG. 8 is a signal flow diagram of a messaging method based on a public phone number according to an embodiment.

With respect to the description of the drawings, the same or similar reference signs may be used for the same or similar elements.

### DETAILED DESCRIPTION OF EMBODIMENTS

Hereinafter, various embodiments of the present disclosure will be described with reference to the accompanying drawings. However, this is not intended to limit the present disclosure to the specific embodiments, and it is to be construed to include various modifications, equivalents, and/or alternatives of embodiments of the present disclosure.

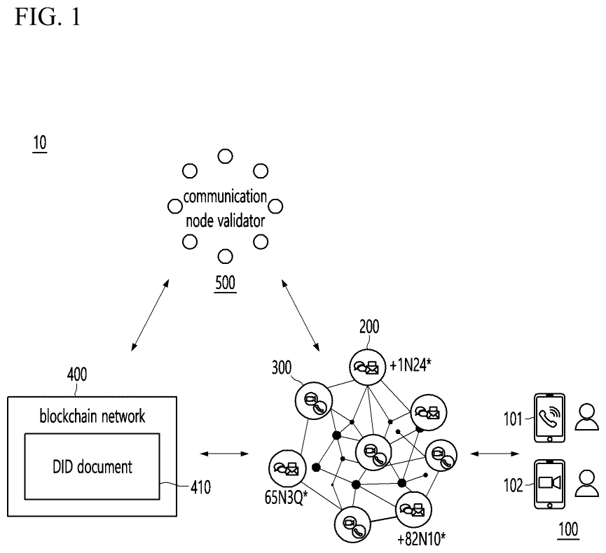

FIG. 1 is a diagram for generally explaining configuration and operation of a communication system 10 according to an embodiment.

According to an embodiment, a communication system 10 may include a plurality of user devices, a plurality of messaging nodes, a plurality of media streaming nodes, a blockchain network 400, and a plurality of communication node validators. In the communication system 10, the plurality of user devices may perform voice calls, video calls, message transmission, and email transmission with other user devices through communication infrastructure provided by the plurality of messaging nodes, the plurality of media streaming nodes, the blockchain network 400, and the plurality of communication node validators. Hereinafter, the explanation of video calls will be replaced with the explanation of voice calls, and the explanation of email transmission will be replaced with the explanation of message transmission.

Hereinafter, descriptions will be provided for a user device 100 included in the plurality of user devices, a messaging node 200 included in the plurality of messaging nodes, a media streaming node 300 included in the plurality of media streaming nodes, and a communication node validator 500 included in the plurality of communication node validators. The descriptions for the user device 100, the messaging node 200, the media streaming node 300, and the communication node validator 500 may be equally applied to all of the plurality of user devices, the plurality of messaging nodes, the plurality of media streaming nodes, and the plurality of communication node validators included in the communication system 10, respectively. In various embodiments, the blockchain network 400 may include at least one blockchain network among known public blockchains.

According to an embodiment, a user device 100 may have a user decentralized identity (hereinafter, DID). The user DID may be understood as an ID on the blockchain network 400. One user device 100 may correspond to one user DID.

The user device 100 may generate a user DID to be used as an ID on the communication system 10. The User DID may be understood as an ID that may be used as an account on the blockchain network 400. The user device 100 may generate a pair of private key/public key (hereinafter, user private key/user public key) corresponding to the user DID. The user public key may be mapped to the user DID and stored in the blockchain network 400. The user private key may be used to generate an electronic signature of the user device 100 to be used on the communication system 10. Hereinafter, the electronic signature generated using the user private key may be referred to as the electronic signature based on the user DID. In various embodiments, the user DID and user public key may be same.

The user device 100 may include a memory storing the user DID, the user private key, and the user public key. The user device 100 may include at least one processor. The at least one processor may control the overall operation of the user device 100. Hereinafter, operations of the user device 100 may be understood as operations of the at least one processor.

The user device 100 may itself generate a phone number to be used on the communication system 10. The user device 100 may generate multiple phone numbers and use them on the communication system 10.

Phone numbers on the communication system 10 may be classified into two types: private phone numbers and public phone numbers. According to an embodiment, a private phone number may be understood as a phone number where the number's creator designates specific user(s) with whom to communicate via the private phone number, and the private phone number is used privately only between the number's creator and the specified user(s). According to an embodiment, a public phone number, similar to phone numbers in existing communication systems, allows anyone who knows the public phone number to communicate with the creator of the public phone number via the public phone number.

When generating a phone number, the user device 100 may determine the type of the phone number. Private phone numbers may be classified into two types: 1:1 private phone numbers and group private phone numbers, depending on whether the phone number is shared with one person or multiple people. Therefore, phone numbers in the communication system 10 will have one of three type information: 1:1 private phone number, group private phone number, or public phone number. When generating a phone number, the user device 100 specifies one of these three types.

In various embodiments, when generating a phone number, the user device 100 can set a validity period for the phone number. For example, if the validity period is set to 5 days, that phone number can be set to become unusable 5 days after its generation. In another example, if the user device 100 does not set a validity period for the phone number, that phone number may continue to be used unless deleted by the user device 100. The set validity period may be modified by the user device 100.

The communication system 10 includes communication nodes for providing communication functions such as calls, messages, and video calls on the communication system 10. The communication nodes may be classified into messaging nodes 200 and media streaming nodes 300.

According to an embodiment, a messaging node 200 may be understood as a server device that mediates communication between different user devices. The blockchain network 400 may store node information of the messaging node 200 (e.g., operator's personal information, regional information where the server is installed and operated, information about the messaging node's endpoint (hereinafter, service endpoint)). The user device 100 may retrieve node information about the messaging node 200 through the blockchain network 400 and may select a messaging node 200 to use.

The following table explains the phone number system of the communication system 10 according to various embodiments. A phone number in the communication system 10 may consist of a prefix and an arbitrary string. A prefix may be understood as a code related to the messaging node 200 responsible for mediating communication for a specific phone number. The arbitrary string may be understood as a string randomly generated by the phone number creator (user device 100), which may include numbers and characters.

TABLE 1

| Prefix | | |
|---|---|---|
| Regional Code | Random Code | Arbitrary String |
| Code related to the | Arbitrary string assigned | String randomly |
| country and/or region | to the messaging node | generated by the user |
| where the messaging | 200 by the | (including numbers |
| node 200 is located | communication node | and characters) |
| | validator 500 | |

In various embodiments, anyone may operate a messaging node 200 by following the protocol of the communication system 10. Therefore, the communication system 10 may include a plurality of messaging nodes. Each of the plurality of messaging nodes may have a pre-assigned prefix. For example, the regional code included in the prefix may be determined similarly to the international calling country codes used in existing communication systems. When the messaging node 200 is located in the United States, it may have +1N as its regional code, and when in Korea, it may have +82N. However, the regional code is not limited to these and may be newly defined on the communication system 10. Since the operator of the messaging node 200 according to the present disclosure may autonomously select the region to operate the node, and users of the communication system 10 are not limited to specific countries or regions, problems such as traffic concentration in specific regions may occur. Through the regional code of the messaging node 200, traffic on the communication system 10 may be guided to be evenly distributed.

In various embodiments, the prefix may further include a random code assigned to the messaging node 200. For example, the random code of the prefix may be understood as an arbitrary string determined by the communication node validator 500. This will be explained in the registration process of the messaging node 200 by the communication node validator 500.

Therefore, a phone number on the communication system 10 may consist of the prefix of the messaging node 200 matched with that phone number and an arbitrary string generated by the user device 100. For example, if the user device 100 selects a first messaging node 2100 with prefix+82N24 and generates a string 7QK39A, the phone number becomes +82N247QK39A. In various embodiments, the string may include both numbers and characters (e.g., alphabets).

The messaging node 200 may include memory for storing communication records (e.g., messages, call history) between a plurality of user devices. When a user device 100 generates a phone number, the messaging node 200 may allocate a storage space (hereinafter, room) corresponding to the phone number from the memory. Therefore, the phone number may be an identifier for a room.

According to an embodiment, a 1:1 private phone number may be shared with one other user device after being generated by the user device 100. A 1:1 private phone number may be understood as a phone number that only one other user device shared after the number's generation may contact. For example, a 1:1 private phone number+1N24BROWNIE37 generated by the first user device 101 may be shared with the second user device 102. In this case, +1N24BROWNIE37 becomes a phone number that enables contact only between the first user device 101 and the second user device 102, and a room with the identifier+1N24BROWNIE37 may be created in the first messaging node 2100. Communication records (e.g., encrypted messages, call history) between the first user device 101 and the second user device 102 may be stored in the room. No user devices other than the first user device 101 and the second user device 102 may connect to the +1N24BROWNIE37 room.

According to an embodiment, a group private phone number may be understood as a private phone number with a set number of participating users (e.g., 10 people). A group private phone number can be set so that after the group private phone is created by a user device (100) and shared with as many other user devices as the number of participating users, no other user devices can participate. Multiple user devices that have joined the group private phone number may perform multi-party communication through the group private phone number. For example, if a group private phone number+1N2455476083 generated by the first user device 101 has 3 participating users, a room with the identifier+1N2455476083 may be created in the first messaging node 2100, and a total of 3 user devices including the first user device 101 may connect to the +1N2455476083 room.

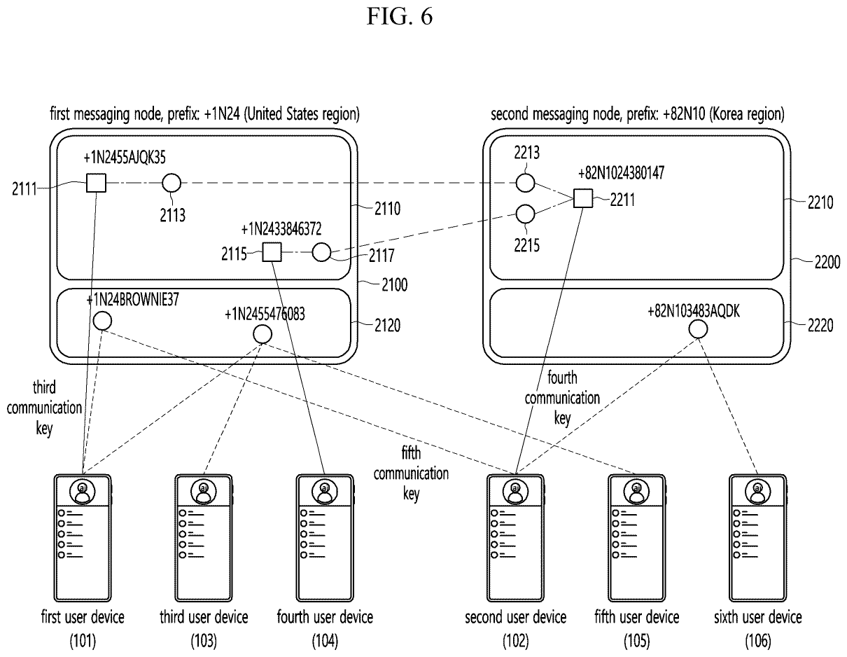

According to an embodiment, a public phone number, like conventional phone numbers, may be configured to allow anyone who has received the public phone number to communicate via the public phone number. User devices connected via public phone numbers perform one-to-one communication. Detailed explanation of this will be described later through FIGS. 6 to 8.

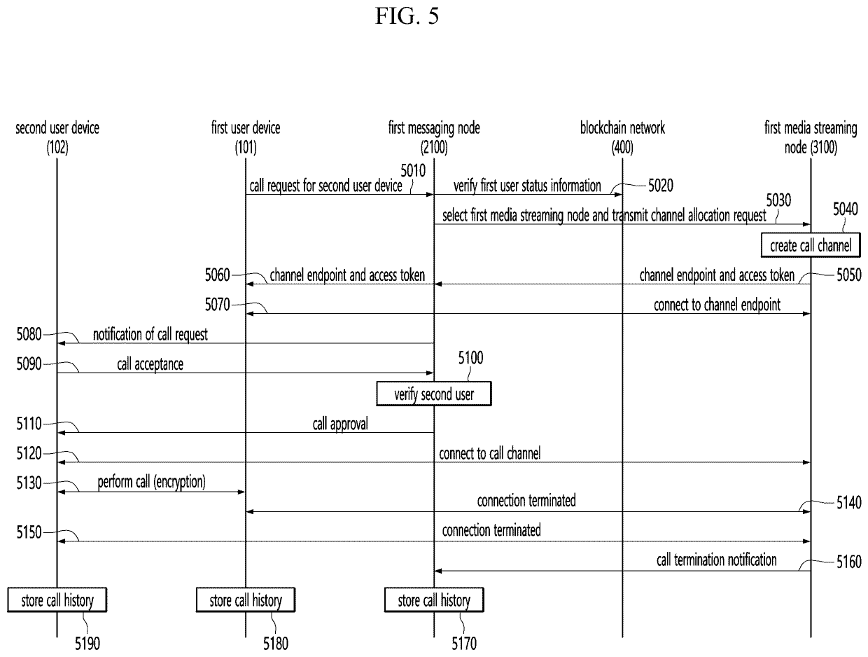

The media streaming node 300 may be understood as a node that streams voice data and video data generated when voice and video calls are performed between different user devices. The media streaming node 300 may be configured to communicate with the messaging node 200 rather than directly communicating with the user device 100. When the messaging node 200 receives a voice call or video call request between user devices, the messaging node 200 may select an available media streaming node 300. The selected media streaming node 300 may provide a data streaming channel for voice and video data between user devices. The messaging node 200 and media streaming node 300 operate as a single communication network. Detailed explanation of this will be described later through FIG. 5.

In various embodiments, the communication node validator 500 may be understood as an entity that monitors communication nodes, namely the messaging node 200 and media streaming node 300 on the communication system 10. The communication node validators, as entities having authority to input external data to be recorded in the blockchain network 400, may have their DIDs pre-registered in the blockchain network 400 (DID document). According to an embodiment, the communication node validator 500 may transmit data to smart contracts to allow data to be brought in from or sent out to external sources of the blockchain network 400.

The communication node validator 500 may monitor the operational status of communication nodes (hereinafter, node operational status), such as whether the messaging node 200 and media streaming node 300 are operating in accordance with the established protocols of the communication system 10, and may record the node operational status in the blockchain network 400. Additionally, the communication node validator 500 may verify node information (e.g., operator's personal information, regional information, service endpoint) of the messaging node 200 and media streaming node 300, and may record the node information in the blockchain network 400. The user device 100 may select a messaging node to send phone number registration requests to by referring to the node information and the node operational status of messaging nodes recorded in the blockchain network 400.

In various embodiments, the communication node validator 500 may process the registration of messaging nodes 200 and media streaming nodes 300 to the communication system 10. Since anyone may operate a communication node, verification is needed regarding whether resources for operating the communication node are equipped and in which region the server will be installed. The communication node validator 500 may verify whether a communication node has qualifying eligibility and may register qualified communication nodes to the communication system 10. For example, the communication node validator 500 may register the communication node's DID in the blockchain network 400 and store the communication node's node information and node operational status mapped to the communication node's DID in the blockchain network 400. The prefix of the messaging node 200 may be determined during this registration process.

In various embodiments, when registering a messaging node 200 to the communication system 10, the communication node validator 500 may assign a prefix corresponding to the messaging node 200. The communication node validator 500 may determine a regional code based on the messaging node's operational region and may determine a random code that does not overlap with other messaging nodes in that region. The prefix of the messaging node 200 may be determined by the regional code and random code. During the registration process of the messaging node 200, the communication node validator 500 may record the prefix of the messaging node 200 in the blockchain network 400. Any user of the communication system 10 may identify the messaging node 200 managing a particular phone number through the prefix of the phone number.

In various embodiments, the communication node validator 500 may process compensation procedures for the messaging node 200 and media streaming node 300. The communication node validator 500 may monitor the operational status of communication nodes and determine compensation to be paid to each communication node. Additionally, the communication node validator 500 may determine penalties to be imposed on each communication node when problems occur in their operational status. These compensation and penalty determinations may be enforced to be decided by a majority of the plurality of communication node validators.

In various embodiments, the DID document 410 of the blockchain network 400 may store information associated with user DIDs. Other entities on the communication system 10 may retrieve the DID document 410 based on the user DID and retrieve information associated with the user device 100.

In various embodiments, information associated with the user device 100 stored in the DID document 410 of the blockchain network 400 (hereinafter, user information) may include the user DID, user status information, and user public key. User status information refers to information about usage rights for the communication system 10, and may include subscribed payment plans, subscription status, payment status, etc. The messaging server 200 may determine whether to process a user's phone number registration request and communication request based on the user status information.

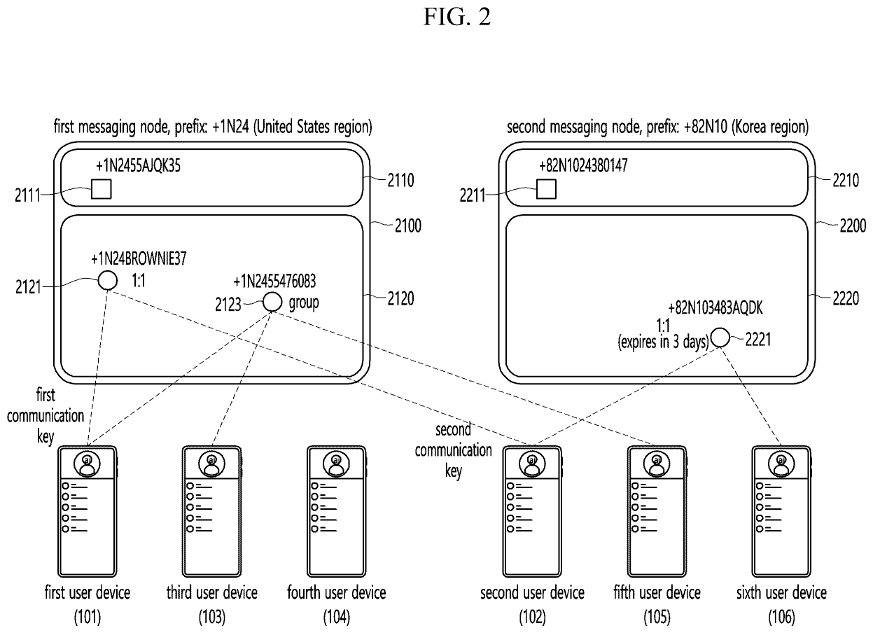

FIG. 2 is a diagram for explaining operations of a messaging node 200 and a user device 100 based on private phone numbers according to an embodiment. Referring to FIG. 2, a first messaging node 2100 and a second messaging node 2200 are illustrated as examples among a plurality of messaging nodes (e.g., messaging node 200). Additionally, first user device 101 through sixth user device 106 are illustrated as examples among a plurality of user devices (e.g., user device 100).

For example, it is assumed that the first messaging node 2100 is a messaging node operating in the United States region with a prefix of +1N24. The second messaging node 2200 is assumed to be a messaging node operating in the Korea region with a prefix of +82N10. The user device 200 may retrieve such node information through the blockchain network 400.

The first messaging node 2100 and second messaging node 2200 may have memory 2120, 2220 for private type phone numbers and memory 2110, 2210 for public type phone numbers. Hereinafter, private type phone numbers and associated data explained through FIGS. 2 to 5 may be stored in the memory for private type phone numbers 2120, 2220, and public type phone numbers and associated data explained through FIGS. 6 to 8 may be stored in the memory for public type phone numbers 2110, 2210.

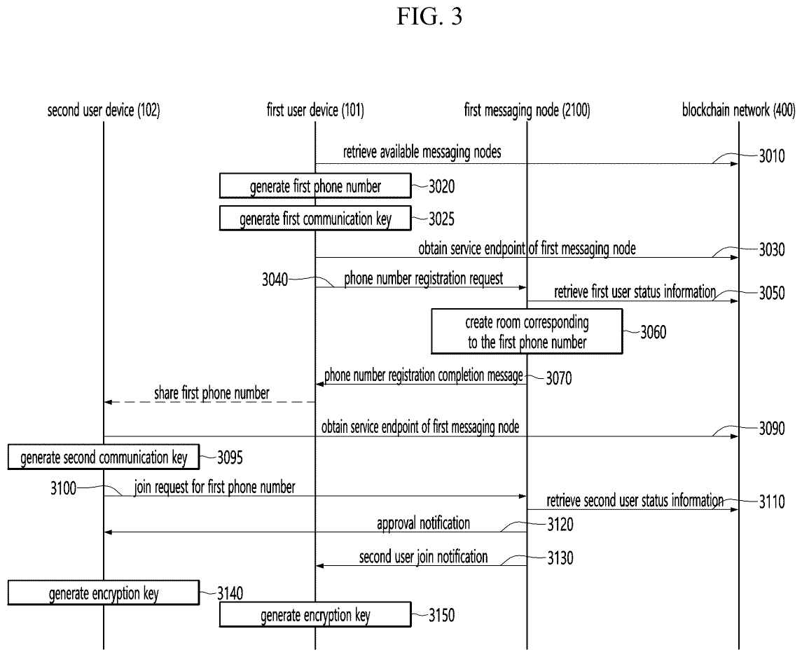

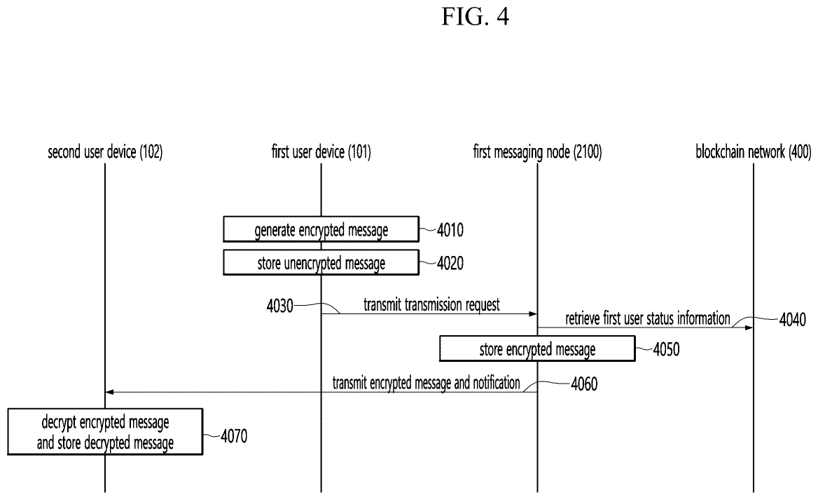

FIG. 3 is a signal flow diagram of a method for generating a 1:1 private phone number according to an embodiment. FIG. 4 is a signal flow diagram of a messaging method based on a 1:1 private phone number according to an embodiment. FIG. 5 is a signal flow diagram of a call method based on a 1:1 private phone number according to an embodiment. Hereinafter, referring to FIGS. 2 to 5, a communication method based on a 1:1 private phone number will be explained where the first user device 101 generates a 1:1 private phone number and shares the 1:1 private phone number with the second user device 102. The operations of the first user device 101 and second user device 102 may be performed in the same way by a plurality of user devices, and the operations of the first messaging node 2100 may be performed in the same way by a plurality of messaging nodes.

According to an embodiment, the first user device 101 may correspond to a first user DID, and the second user device 102 may correspond to a second user DID. Each user device's user DID may be understood as the user device's ID in the communication system 10.

According to an embodiment, the first user device 101 may retrieve available messaging nodes through the blockchain network 400 (3010), and may generate a first phone number having a prefix corresponding to the first messaging node 2100 among the available messaging nodes (3020). The first user device 101 may generate a first communication key corresponding to the first phone number (3025).

In operation 3010, the first user device 101 may retrieve a list of selectable messaging nodes and node information and node operational information of messaging nodes included in the list through the blockchain network 400. In FIG. 2, an example is illustrated where the first user device 101 has selected the first messaging node 2100.

In operation 3020, the first user device 101 may retrieve the prefix of the first messaging node 2100 through the blockchain network 400. The first user device 100 may generate a phone number that includes the prefix of the first messaging node 2100. Therefore, through the prefix, it may be confirmed which messaging node manages a particular phone number. The first user device 101 may generate an arbitrary string and generate a first phone number including the arbitrary string and the prefix.

In operation 3025, the first communication key may include a first communication DID and a pair of private key/public key corresponding to the first communication DID (hereinafter, first communication private key, first communication public key). The first communication DID and first communication public key may be stored in the DID document 410 of the blockchain network 400. The first user device 101 may generate the first communication DID corresponding to the first phone number and the first communication private key and first communication public key corresponding to the first communication DID. In various embodiments, the first communication DID may be identical to the first communication public key.

In various embodiments, when the user device 100 generates a phone number, the user device 100 may generate a communication key corresponding to that phone number. The communication key may include a communication DID and a pair of private key/public key corresponding to the communication DID (hereinafter, communication private key, communication public key). The communication DID may be used for key exchange to generate the same encryption key between user devices performing communication through the phone number to be generated. A communication DID may be understood as a key exchanged to generate an encryption key necessary for encrypting communication data (e.g., message data, voice data, etc.) on the communication system 10. In various embodiments, the communication DID may be identical to the communication public key.

Referring to FIG. 2, an example is illustrated where the first user device 101 generated+1N24BROWNIE37 as the first phone number by combining the first messaging node 2100's prefix+1N24 with the arbitrary string BROWNIE37.

Referring back to FIG. 3, the first user device 101 may obtain the service endpoint of the first messaging node 2100 from the blockchain network 400 based on the prefix of the first messaging node 2100 included in the first phone number (3030). The service endpoint may be understood as one of the node information of the first messaging node 2100. The first user device 101 may transmit various requests necessary for using the communication system 10 to the first messaging node 2100 via the service endpoint of the first messaging node 2100.

In various embodiments, before the user device 100 transmits various data including requests (e.g., phone number registration request, message transmission request, call request, etc.) to the messaging node 200, the user device 100 may obtain the service endpoint of the messaging node 200 based on the prefix included in the intermediary phone number. Hereinafter, the process of the user device 100 obtaining the service endpoint of the messaging node 200 that manages the phone number based on the prefix included in the phone number may be omitted.

The first user device 101 may transmit a first phone number registration request to the first messaging node 2100 based on the service endpoint of the first messaging node 2100 (3040). The first phone number registration request may include the first user DID, the first electronic signature based on the first user DID, the first communication DID, and type information of the first phone number. The first phone number type information may be ‘1:1 private’.

The first messaging node 2100 may retrieve first user status information from the blockchain network 400 based on the first user DID (3050), and may create a storage space (room) corresponding to the first phone number (3060). In operation 3060, the first messaging node 2100 may store the first communication DID to correspond to the first phone number and the first user device 101. The first communication DID may be understood as being generated by the first user device 101 and corresponding to the first phone number.

When the creation of the storage space (room) is completed, the first messaging node 2100 may transmit a phone number registration completion message to the first user device 101 (3070).

In operations 3050 and 3060, the first messaging node 2100 may retrieve user status information from the DID document 410 of the blockchain network 400, and may allocate a storage space corresponding to the first phone number (hereinafter, first room 2121) only when the first user device 101 has the authority to register the first phone number. The first phone number may serve as an identifier for the first room 2121. Referring to FIG. 2, an example is illustrated where the first room 2121 is created for the first phone number +1N24BROWNIE37.

Upon receiving the phone number registration completion message, the first user device 101 may share the first phone number with the second user device 102 (3080). The second user device 102 may be understood as the device of the counterpart user with whom 1:1 private communication will be performed using the first phone number of the first user device 101. For example, the first user device 101 may share the first phone number with the second user device 102 directly through device-to-device short-range communication or offline, rather than via the communication system 10. The second user device 102 that received the first phone number may perform the connection process to the first phone number (3090 to 3130)

The second user device 102 may obtain the service endpoint of the first messaging node 2100 from the blockchain network 400 based on the first phone number (3090). The second user device 102 may generate a second communication key corresponding to the first phone number (3095) and transmit a join request for the first phone number to the first messaging node 2100 (3100).

In operation 3095, the second communication key may include a second communication DID and a pair of private key/public key corresponding to the second communication DID (hereinafter, second communication private key, second communication public key). The second communication DID and second communication public key may be stored in the DID document 410 of the blockchain network 400. The second user device 101 may generate the second communication DID corresponding to the first phone number and the second communication private key and second communication public key corresponding to the second communication DID. In various embodiments, the second communication DID may be identical to the second communication public key.

In operation 3100, the join request for the first phone number may include the second user DID, the second electronic signature based on the second user DID, and the second communication DID. The first messaging node 2100 may store the second communication DID to correspond to the first phone number and second user device 102. The second communication DID may be understood as being generated by the second user device 102 and corresponding to the first phone number.

The first messaging node 2100 may retrieve second user status information from the blockchain network 400 based on the second user DID (3110). The first messaging node 2100 may verify based on the second user status information whether the second user device 102 has authority to join the first phone number. If authority is verified, the first messaging node 2100 may transmit an approval notification to the second user device 102 (3120) and may transmit a second user join notification to the first user device 101 (3130).

The approval notification of operation 3120 may include the first communication DID, and the second user join notification of operation 3130 may include the second communication DID. Through operations 3120 and 3130, the first user device 101 and second user device 102 exchange the first communication DID and second communication DID, and exchange each other's public keys (first communication public key, second communication public key). The first user device 101 and second user device 102 may generate the same encryption key by exchanging public keys (Diffie-Hellman key exchange). The first user device 101 and second user device 102 may encrypt or decrypt data using the same encryption key.

The first user device 101 may generate an encryption key based on the first communication private key and second communication DID (3140). The first user device 101 may obtain the second communication public key stored in the DID document 410 of the blockchain network 400 based on the second communication DID (DID resolution). The first user device 101 may generate the encryption key based on the second communication public key and the first communication private key. The second communication public key may be obtained based on the second communication DID.

The second user device 102 may generate the encryption key based on the second communication private key and first communication DID (3150). The second user device 102 may obtain the first communication public key stored in the DID document 410 of the blockchain network 400 based on the first communication DID (DID resolution). The second user device 102 may generate the encryption key based on the first communication public key and the second communication private key. The first communication public key may be obtained based on the first communication DID.

Referring back to FIG. 2, the identifier of the first room 2121 becomes +1N24BROWNIE37 (first phone number), and the first communication key of the first user device 101 and the second communication key of the second user device 102 may be used to generate an encryption key used when performing communication via the first room 2121. Since the first phone number has a 1:1 private type, no other user devices (e.g., first user device 103 through sixth user device 106) may newly connect other than the first user device 101 and second user device 102 already connected to the first phone number.

Hereinafter, referring to FIG. 4, a messaging method performed by the first user device 101 and second user device 102 connected to the first phone number in FIG. 3 will be explained.

The first user device 101 may generate an encrypted message based on the encryption key (4010). The first user device 101 may generate a message to be sent to the second user device 102 and may encrypt the generated message using the encryption key. The first user device 101 may store the unencrypted message in the first user device 101 (4020).

The first user device 101 may transmit a transmission request for the encrypted message to the first messaging node 2100 (4030). The transmission request for the encrypted message may include the first user DID and the first electronic signature based on the first user DID.

The first messaging node 2100 may retrieve first user status information from the blockchain network 400 based on the first user DID (4040), and may transmit the encrypted message and notification to the second user device 102 (4060). The first messaging node 2100 may perform operation 4060 only when the first user status information indicates that the first user device 101 has authority to transmit messages. In another example, if the first user device 101 does not have authority to transmit messages, the first messaging node 2100 may transmit a response rejecting the message transmission request to the first user device 101.

The first messaging node 2100 may store the encrypted message in the first room 2121 (4050). Since messages generated between the first user device 101 and second user device 102 are stored in encrypted form, the first messaging node 2100 does not have access rights to the decrypted message content.

The second user device 102 that received the encrypted message may decrypt the encrypted message based on the encryption key and store the decrypted message (4070). Therefore, the original message may be stored only in the first user device 101 and second user device 102.

Hereinafter, referring to FIG. 5, a call method based on a 1:1 private phone number will be explained. Calls on the communication system 10 may include voice calls and video calls.

The first user device 101 may transmit a call request for the second user device 102 to the first messaging node 2100 (5010). The call request may include the first user DID and the first electronic signature based on the first user DID.

The first messaging node 2100 may verify first user status information through the blockchain network 400 based on the first user DID (5020). The first messaging node 2100 may verify based on the first user status information whether the first user device 101 has authority to make a call request.

If the first user device 101 has authority to make a call request, the first messaging node 2100 may retrieve available media streaming nodes through the blockchain network 400, select a first media streaming node 3100 among the available media streaming nodes, and transmit a channel allocation request for the call request to the first media streaming node (5030).

The first media streaming node 3100 may create call channel corresponding to the channel allocation request (5040), and may transmit an endpoint of the created call channel (hereinafter, channel endpoint) and an access token for the call channel to the first messaging node 2100 (5050). The first messaging node 2100 may transmit the channel endpoint and the access token for the call channel to the first user device 101 (5060). The first user device 101 may connect to the channel endpoint based on the access token (5070).

When the first user device 101's connection to the call channel is completed, the first messaging node 2100 may transmit a notification of the call request to the second user device 102 (5080). The second user device may transmit a call acceptance including the second electronic signature based on the second user DID to the first messaging node 2100 (5090).

The first messaging node 2100 may verify based on the second electronic signature whether the call acceptance was received from the second user device 102 having the second user DID (5100), and may transmit the channel endpoint and access token for the call channel to the second user device 102 (5110). The second user device 102 may connect to the channel endpoint based on the access token (5120).

When both the first user device 101 and second user device 102 have connected to the call channel, and the first user device 101 and second user device 102 are connected through the call channel, the call may begin (5130). Voice data and video data transmitted and received during calls between the first user device 101 and second user device 102 may be encrypted based on the encryption key generated in operations 3170 and 3180 of FIG. 3 and transmitted. For example, a user's voice data (speech data) and/or video data input through the first user device 101 may be encrypted by the encryption key and transmitted to the second user device 102 through the call channel. The second user device 102 may decrypt the encrypted voice data and/or video data using the encryption key.

When the call between the first user device 101 and second user device 102 ends, the connection between the first user device 101 and first media streaming node 3100 and the connection between the second user device 102 and first media streaming node 3100 may be terminated (5140, 5150).

When the connections of the first user device 101 and second user device 102 to the call channel are terminated, the first media streaming node 3100 may transmit a call termination notification to the first messaging node 2100 (5160). The call termination notification may include call history information. The call history information may include call date and time information. The first messaging node, first user device 101, and second user device 102 may each store the call history (5170, 5180, 5190).

Through FIGS. 3 to 5 described above, the first user device 101 may retrieve available messaging nodes through the blockchain network 400 and generate a first phone number having a prefix corresponding to the first messaging node 2100 among the available messaging nodes (e.g., operation 3020 of FIG. 3). The first user device 101 may generate a first communication DID corresponding to the first phone number and a first communication private key and first communication public key corresponding to the first communication DID (e.g., operation 3025 of FIG. 3). The first user device 101 may obtain a first service endpoint of the first messaging node 2100 from the blockchain network 400 (e.g., operation 3030 of FIG. 3).

The first user device 101 may transmit a first phone number registration request of private 1:1 type to the first messaging node 2100 based on the first service endpoint (e.g., operation 3040 of FIG. 3). The first phone number registration request may include an electronic signature based on the first user DID and the first communication DID.

After registration of the first phone number is completed, the first user device 101 may share the first phone number with the second user device 102. Subsequently, the first user device 101 may receive a join notification for the first phone number from the second user device 102 (e.g., process of operations 3100 to 3130 of FIG. 3). The join notification may include the second communication DID generated by the second user device 102. The first user device 101 may receive the second user device 102's join notification for the first phone number (e.g., second user join notification of operation 3130 of FIG. 3) from the first messaging node 2100 through the process of operations 3100 to 3130 of FIG. 3.

To generate an encryption key for use in communication with the second user device 102, the first user device 101 may generate the encryption key based on the second communication DID generated by the second user device 102 and the first communication private key (e.g., operation 3150 of FIG. 3). The first user device 101 may obtain the second communication public key based on the second communication DID and generate the encryption key using the second communication public key and first communication private key. In this way, when the first user device 101 and second user device 102 are connected via the first phone number, the first user device 101 and second user device 102 may send messages to each other or perform calls via the first phone number.

The first user device 101 may transmit messages encrypted with the encryption key to the first messaging node 2100 (e.g., operation 4030 of FIG. 4), and the encrypted messages may be transmitted to the second user device 102 by the first messaging node 2100.

The first user device 101 may transmit a call request with the second user device 102 based on the first phone number to the first messaging node 2100 (e.g., operation 5010 of FIG. 5). The first user device 101 may receive an endpoint for a call channel for transmitting media data of the call request and an access token for the call channel from the first messaging node 2100 (e.g., operation 5050 of FIG. 5). The first user device 101 may connect to the endpoint for the call channel based on the access token (e.g., operation 5070 of FIG. 5). After the first user device 101, which initiated the call request, connects to the call channel, the first messaging node 2100 sends a call request notification to the second user device 102, and through a predetermined process, the second user device 102 connects to the created call channel (e.g., operations 5080 to 5120 of FIG. 5). After connecting to the same call channel, the first user device 101 and second user device 102 perform the call. For example, when a voice call is performed, the first user device 101 may encrypt voice data obtained from the user based on the encryption key generated in operation 3150 of FIG. 3, and may transmit the encrypted voice data to the second user device 102 via the call channel.

In another embodiment, the first user device 101 may generate a second phone number of private group type. The first user device 101 may generate the second phone number in the same way as operations 3010 to 3070 of FIG. 3, and the first messaging node 2100 may generate a storage space corresponding to the second phone number.

Referring to FIG. 2, an example is illustrated where the first user device 101 generated+1N2455476083 as the second phone number by combining the first messaging node 2100's prefix+82N24 with the arbitrary string 55476083. For example, the type information of the second phone number may be set as group private with three participating users. The first messaging node 2100 may generate a second room 2123 as a storage space corresponding to the second phone number. The second room 2123 has the first user device 101, third user device 103, and fifth user device 105 connected. In the case of group communication with a plurality of user devices participating, it may be performed encrypted through a group messaging protocol applying end-to-end encryption such as MLS (Message Layer Security).

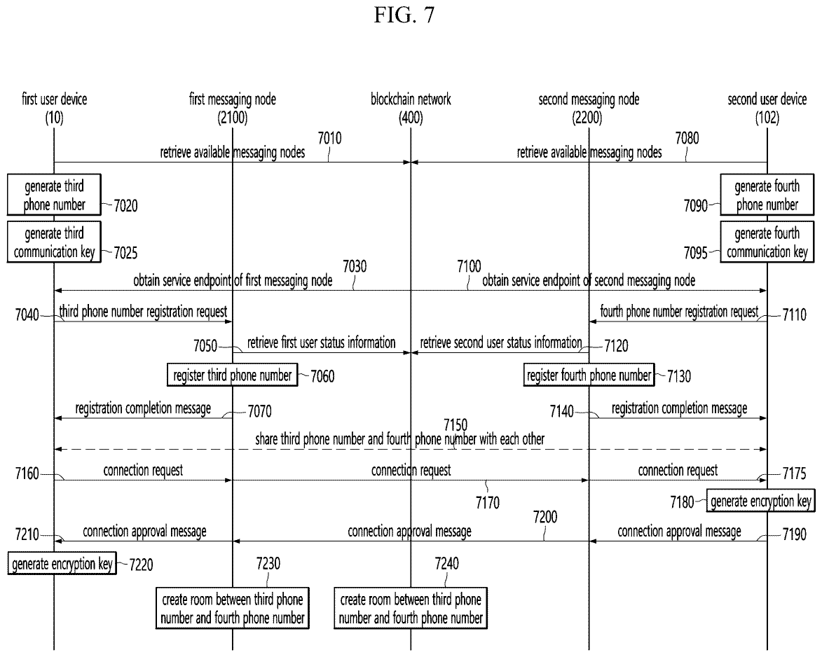

FIG. 6 is a diagram for explaining operations of a messaging node 200 and a user device 100 based on public phone numbers according to an embodiment. The description of FIG. 2 above applies equally to FIG. 6. FIG. 7 is a signal flow diagram of a method for generating a public phone number according to an embodiment.

Hereinafter, referring to FIGS. 6 to 8, a communication method based on public phone numbers will be explained where the first user device 101 and second user device 102 each generate public phone numbers, and communication is performed between the first user device 101 and second user device 102. The operations of the first user device 101 and second user device 102 may be performed by a plurality of user devices in the same way, and the operations of the first messaging node 2100 and second messaging node 2200 may be performed by a plurality of messaging nodes in the same way.

The first user device 101 may retrieve available messaging nodes through the blockchain network 400 (7010), and may generate a third phone number having a prefix corresponding to the first messaging node 2100 among the available messaging nodes (7020). The first user device 101 may generate a third communication key corresponding to the third phone number (7025). The third communication key may include a third communication DID and a pair of private key/public key corresponding to the third communication DID (hereinafter, third communication private key, third communication public key). The third communication DID and the third communication public key may be stored in the DID document 410 of the blockchain network 400.

The first user device 101 may obtain the service endpoint of the first messaging node 2100 through the blockchain network 400 (7030). The first user device 101 may transmit a third phone number registration request to the first messaging node 2100 based on the service endpoint of the first messaging node 2100 (7040).

The third phone number registration request may include the first user DID, the electronic signature based on the first user DID, the third communication DID, and type information of the third phone number. The type information of the third phone number may be public. The first messaging node 2100 may retrieve first user status information based on the first user DID from the blockchain network 400 (7050) and register the third phone number (7060). The first messaging node 2100 may store the third communication DID to correspond to the third phone number and first user device 101. When registration of the third phone number is completed, the first messaging node 2100 may transmit a registration completion message for the third phone number to the first user device (7070).

Referring to FIG. 6, an example is illustrated where the first user device 101 generated+1N2455AJQK35 as the third phone number by combining the first messaging node 2100's prefix+1N24 with the arbitrary string 55AJQK35. An example is illustrated where a first item 2111 for the third phone number+1N2455AJQK35 is created in the memory 2110 for public type phone numbers of the first messaging node 2100. Since the third phone number is a public phone number, it may be connected with public phone numbers of a plurality of other user devices. Therefore, for the third phone number registration request, the first messaging node 2100 may allocate the first item 2111 as a storage space for the third phone number, and when a connection request with other public phone numbers is received later, the first messaging node 2100 may create a storage space (room) between those other public phone numbers and the third phone number connected to the first item 2111.

The second user device 102 may retrieve available messaging nodes through the blockchain network 400 (7080), and may generate a fourth phone number having a prefix corresponding to the second messaging node 2200 among the available messaging nodes (7090). The second user device 102 may generate a fourth communication key corresponding to the fourth phone number (7095). The fourth communication key may include a fourth communication DID and a pair of private key/public key corresponding to the fourth communication DID (hereinafter, fourth communication private key, fourth communication public key). The fourth communication DID and fourth communication public key may be stored in the DID document 410 of the blockchain network 400.

The second user device 102 may obtain the service endpoint of the second messaging node 2200 through the blockchain network 400 (7100). The second user device 102 may transmit a fourth phone number registration request to the second messaging node 2200 based on the service endpoint of the second messaging node 2200 (7110). The fourth phone number registration request may include the second user DID, the electronic signature based on the second user DID, the fourth communication DID, and type information of the fourth phone number. The type information of the fourth phone number may be ‘public’.

The second messaging node 2200 may retrieve second user status information from the blockchain network 400 based on the second user DID (7120) and register the fourth phone number (7130). The second messaging node 2200 may store the fourth communication DID to correspond to the fourth phone number and second user device 102. When registration of the fourth phone number is completed, the second messaging node 2200 may transmit a creation completion message for the fourth phone number to the second user device 102 (7140).

Referring to FIG. 6, an example is illustrated where the second user device 102 generated+82N1024380147 as the fourth phone number by combining the second messaging node 2200's prefix+82N10 with the arbitrary string 24380147. An example is illustrated where the second item 2211 for the fourth phone number+82N1024380147 is created in the memory 2210 for public type phone numbers of the second messaging node 2200. Since the fourth phone number is a public phone number, the fourth phone number may be connected with public phone numbers of a plurality of other user devices. Therefore, for the fourth phone number registration request, the second messaging node 2200 may allocate the second item 2211 for the fourth phone number, and when a connection request with other public phone numbers is received later, the second messaging node 2200 may create a storage space (room) between those other public phone numbers and the fourth phone number connected to the second item 2211.

After their respective public phone numbers are registered, the first user device 101 and second user device 102 may share the third phone number and fourth phone number with each other (7150). For example, the first user device 101 and second user device 102 may share their third phone number and fourth phone number with each other through device-to-device short-range communication or offline, rather than through the communication system 10.

According to an embodiment, the first user device 101 may transmit a connection request between the third phone number and the fourth phone number to the first messaging node 2100 (7160). The connection request between the third phone number and the fourth phone number may include the first user DID, the first electronic signature based on the first user DID, the third communication DID, the third phone number, and the fourth phone number.

For example, before the third phone number and fourth phone number are connected on the first messaging node 2100 and second messaging node 2200, if the first user device 101 sends a call connection request or message transmission request from its third phone number to the fourth phone number to the first messaging node 2100, such call connection request or message transmission request may include the connection request between the third phone number and the fourth phone number. That is, the processing of the connection request between the third phone number and the fourth phone number may be performed once when communication is first performed between the third phone number and fourth phone number. Therefore, the connection request between the third phone number and the fourth phone number may correspond to either a call connection request from the third phone number to the fourth phone number initiated by the first user device 101 or a message transmission request from the third phone number to the fourth phone number initiated by the first user device 101.

When the first messaging node 2100 receives the connection request between the third phone number and the fourth phone number (7160), the first messaging node 2100 may transmit the connection request between the third phone number and fourth phone number to the second messaging node 2200 that manages the fourth phone number (7170). The second messaging node 2200 may transmit the connection request between the third phone number and fourth phone number to the second user device 102 (7175).

The second user device 102 may generate an encryption key based on the third communication key included in the connection request between the third phone number and fourth phone number and the second communication private key (7180). The second user device 102 may obtain the third communication public key stored in the DID document 410 of the blockchain network 400 based on the third communication DID (DID resolution). The second user device 102 may generate the encryption key based on the third communication public key and the second communication private key.

The second user device 102 may transmit a connection approval message for the connection request between the third phone number and fourth phone number to the second messaging node 2200 (7190). The second messaging node 2200 may transmit the connection approval message to the first messaging node 2100 (7200), and the first messaging node 2100 may transmit the connection approval message to the first user device 101 (7210). The connection approval message may include the second user DID, the second electronic signature based on the second user DID, and the fourth communication DID.

The first user device 101 may generate the encryption key based on the fourth communication key included in the connection approval message and the first communication private key (7220). The first user device 101 may obtain the fourth communication public key stored in the DID document 410 of the blockchain network 400 based on the fourth communication DID (DID resolution). The first user device 101 may generate the encryption key based on the fourth communication public key and the first communication private key.

The first messaging node 2100 may create a storage space (third room 2113) between the third phone number and fourth phone number connected to the first item 2111 corresponding to the third phone number (7230).

The second messaging node 2200 may create a storage space (fourth room 2213) between the third phone number and the fourth phone number connected to the second item 2211 corresponding to the fourth phone number (7240).

Referring to FIG. 6, the first messaging node 2100 records communication history between the third phone number and fourth phone number in the third room 2113, and the second messaging node 2200 records communication history between the third phone number and fourth phone number in the fourth room 2213.

In various embodiments, communication history based on private phone numbers may be stored only in the messaging node that created the private phone number (e.g., first messaging node 2100 in FIGS. 2 to 5). However, communication history based on public phone numbers may be stored in each of the messaging nodes that created the public phone numbers participating in the communication (e.g., first messaging node 2100 and second messaging node 2200 in FIGS. 5 to 7).

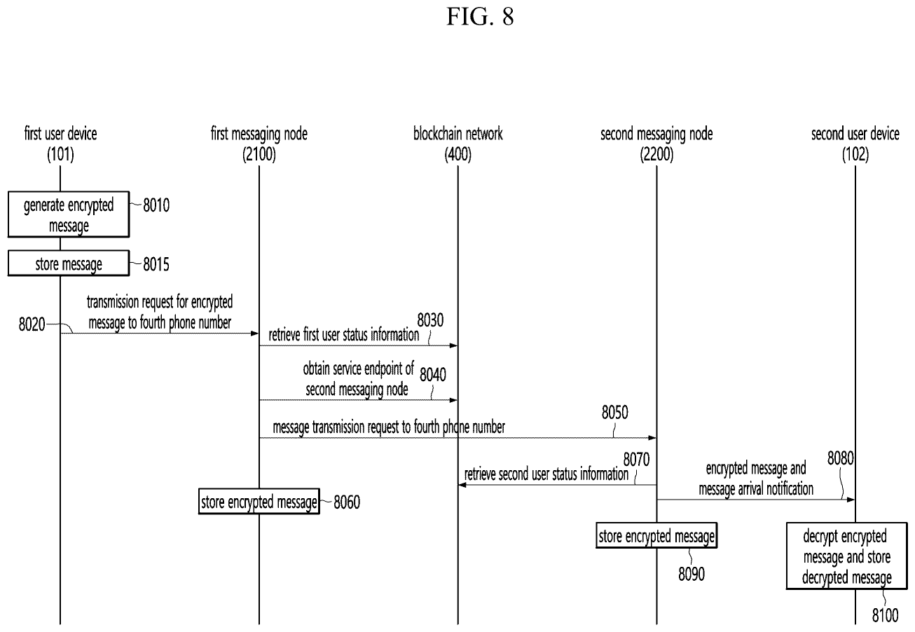

FIG. 8 is a signal flow diagram of a messaging method based on public phone numbers according to an embodiment. Referring to FIG. 8, a messaging method performed based on the third phone number of the first user device 101 and the fourth phone number of the second user device 102 will be explained.

The first user device 101 may generate a message to be sent to the fourth phone number and encrypt the generated message with the encryption key. The first user device 101 may generate an encrypted message based on the encryption key (8010). The first user device 101 may store the unencrypted message in the first user device 101 (8015).

The first user device 101 may transmit a transmission request for the encrypted message to the fourth phone number to the first messaging node 2100 (8020). The transmission request for the encrypted message to the fourth phone number may include the fourth phone number, the first user DID, and the first electronic signature based on the first user DID.

The first messaging node 2100 may retrieve first user status information from the blockchain network 400 based on the first user DID (8030). If the first user device 101 does not have authority to transmit messages, the first messaging node 2100 may transmit a response rejecting the message transmission request to the first user device 101.

If the first user device 101 has authority to transmit messages, the first messaging node 2100 may retrieve through the blockchain network 400 the messaging node to deliver the encrypted message based on the fourth phone number (8030). In operation 8030, the first messaging node 2100 may obtain the service endpoint of the second messaging node 2200 from the blockchain network 400 based on the prefix (+82N10) of the fourth phone number (8040). The first messaging node 2100 may forward the message transmission request to the fourth phone number to the second messaging node 2200 (8050). The first messaging node 2100 may store the encrypted message (8060).

The second messaging node 2200 may retrieve second user status information from the blockchain network 400 based on the second user DID (8070). If the second user device 102 has authority to receive messages, the second messaging node 2200 may transmit the encrypted message and a message arrival notification to the second user device 201 (8080). The second messaging node 2200 may store the encrypted message (8090). The second user device 102 may decrypt the encrypted message with the encryption key and store the decrypted message (8100).

According to various embodiments, a call method based on public phone numbers may be performed similarly to FIG. 5 described above. For example, when the first user device 101 transmits a call request to the fourth phone number to the first messaging node 2100, the first messaging node 2100 may select an available media streaming node (e.g., first media streaming node 3100) and transmit a channel allocation request for the call between the third phone number and fourth phone number to the selected media streaming node (e.g., operations 5010 to 5040 of FIG. 5).

When the call channel is allocated, the endpoint for the call channel (channel endpoint) and the access token may be delivered to the first user device 101 and second messaging node 2200 by the first messaging node 2100. The second messaging node 2200 may then deliver the channel endpoint and the access token to the second user device 102. The first user device 101 and second user device 102 that received the channel endpoint and the access token may perform the call in the same way as operations 5120 to 5160 of FIG. 5. When the call ends, the call history may be stored in the first user device 101, second user device 102, third room 2113 of the first messaging node 2100, and fourth room 2213 of the second messaging node 2200, respectively.

In another example, if the second user device 102 does not have authority to receive messages, the second messaging node 2200 may send a message transmission failure message to the first messaging node 2100, and the first messaging node 2100 may forward the message transmission failure message to the first user device 101.

In various embodiments, phone numbers may have a validity period set. For example, referring to FIG. 2, the second user device 102 may request registration of phone number+82N103483AQDK to the second messaging node 2200 with a 1:1 private phone number type and validity period set to 3 days. When the set validity period has elapsed from the time room 2221 was created for +82N103483AQDK, the second messaging node 2200 may delete room 2221. The first user device 102 and sixth user device 106 that were performing 1:1 communication through phone number+82N103483AQDK and room 2221 will no longer be able to perform communication using phone number+82N103483AQDK.

In various embodiments, the messaging node 200 may manage phone numbers generated by different plurality of user devices (e.g., user device 100). Referring to FIG. 6, an example is illustrated where the fourth user device 104 has created a public phone number+1N2433846372 on the first messaging node 2100. A third item 2115 for phone number+1N2433846372 was created on the first messaging node 2100. The fourth user device 104 may generate a fifth communication key for phone number+1N2433846372, and may use this fifth communication key for key exchange when later connected with other user devices.

In various embodiments, multiple rooms may be connected to items (e.g., first to third items 2111, 2115, 2211) corresponding to public type phone numbers of the messaging node 200. Referring to FIG. 6, the second item 2211 is connected to the fourth room 2213 and fifth room 2215. The fifth room 2215 may be understood as a storage space between the second user device 102's third phone number (+82N1024380147) and the fourth user device's phone number (+1N2433846372). For communication between the third phone number (+82N1024380147) and the fourth user device's phone number (+1N2433846372), the second user device 102 may perform key exchange using the fourth communication key, and the fourth user device 104 may perform key exchange using the fifth communication key (e.g., operations 7175 and 7210 of FIG. 7).

Electronic devices (e.g. first user device 101, second user device 102) according to various embodiments disclosed in this document may be devices of various types. The electronic devices may include, for example, a portable communication device (e.g. smartphone), a computer device, a portable multimedia device, a portable medical device, a camera, a wearable device, or a home appliance. The electronic device according to an embodiment of the present document is not limited to the aforementioned devices.

Various embodiments of this document and terms used therein are not intended to limit the technical features described in this document to specific embodiments, and should be understood to include various modifications, equivalents, or alternatives of the embodiments. In relation to the description of the drawings, similar reference numerals may be used for similar or related components. The singular form of a noun corresponding to an item may include one item or a plurality of items, unless the relevant context clearly dictates otherwise. In this document, each of phrases such as “A or B”, “at least one of A and B”, “at least one of A or B”, “A, B or C”, “at least one of A, B and C”, and “at least one of A, B, or C” may include all possible combinations of items listed together in the corresponding phrase among those phrases. Terms such as “first”, “second”, “firstly”, or “secondly” may simply be used to distinguish a corresponding component from other corresponding components, and do not limit the corresponding components in other respects (e.g., importance or order). In this document, if a certain (e.g., first) element is referred to as being “connected” or “coupled” with or without the terms “functionally” or “communicatively” to another (e.g., second) component, it means that the certain component can be connected to the other component directly (e.g., in a wired manner), wirelessly, or through a third component.

The term “module” used in this document may include a unit implemented in hardware, software, or firmware, and may be used interchangeably with terms such as logic, logic block, component, or circuit. A module may be the smallest unit of an integrated component or a part thereof, performing one or more functions. For example, according to an embodiment, the module may be implemented in the form of an ASIC (application-specific integrated circuit).

Various embodiments as set forth herein may be implemented as software including one or more instructions that are stored in a storage medium that is readable by a machine (e.g., user device 100, messaging node 200). For example, a processor (e.g., the processor 110) of the machine (e.g., user device 100, messaging node 200) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to various embodiments disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single subject or multiple subjects. According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as those performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A communication method performed by a first user device corresponding to a first user DID, a second user device corresponding to a second user DID, and a blockchain network, the method comprising:
retrieving, by the first user device, available messaging nodes through the blockchain network, and generating a first phone number having a prefix corresponding to a first messaging node among the available messaging nodes;
obtaining, by the first user device, a first service endpoint of the first messaging node from the blockchain network based on the prefix;
transmitting, by the first user device, a first phone number registration request to the first messaging node based on the first service endpoint, wherein the first phone number registration request includes the first user DID, a first electronic signature based on the first user DID, and type information of the first phone number, and wherein the first phone number type information is private;
retrieving, by the first messaging node, first user status information from the blockchain network based on the first user DID, and generating a storage space corresponding to the first phone number;
obtaining, by the second user device, the first service endpoint from the blockchain network based on the first phone number;
transmitting, by the second user device, a join request for the first phone number to the first messaging node based on the first service endpoint, wherein the join request includes the second user DID and an electronic signature based on the second user DID; and
retrieving, by the first messaging node, second user status information from the blockchain network based on the second user DID, and transmitting an approval notification to the second user device.

2. The communication method of claim 1, further comprising:
generating, by the first user device, a first communication DID corresponding to the first phone number and a first communication private key and a first communication public key corresponding to the first communication DID;
transmitting, by the first user device, the first phone number registration request including the first communication DID to the first messaging node;
generating, by the second user device, a second communication DID corresponding to the first phone number and a second communication private key and a second communication public key corresponding to the second communication DID;
transmitting, by the second user device, the join request for the first phone number including the second communication DID to the first messaging node;
generating, by the first user device, an encryption key based on the second communication DID and the first communication private key; and
generating, by the second user device, the encryption key based on the first communication DID and the second communication private key.

3. The communication method of claim 2, further comprising:
generating, by the first user device, an encrypted message based on the encryption key;
transmitting, by the first user device, a transmission request for the encrypted message to the first messaging node, wherein the transmission request for the encrypted message includes the first user DID;
retrieving, by the first messaging node, the first user status information from the blockchain network based on the first user DID, and transmitting the encrypted message to the second user device; and
decrypting, by the second user device, the encrypted message based on the encryption key, and storing the decrypted message.

4. The communication method of claim 3, further comprising:
transmitting, by the first user device, a call request for the second user device to the first messaging node;
retrieving, by the first messaging node, available media streaming nodes through the blockchain network, selecting a first media streaming node among the available media streaming nodes, and transmitting a channel allocation request for the call request to the first media streaming node;
transmitting an endpoint for a call channel generated by the first media streaming node to the first messaging node;
transmitting, by the first messaging node, the endpoint for the call channel to the first user device; and
connecting, by the first user device, to the endpoint for the call channel.

5. The communication method of claim 4, further comprising:
transmitting, by the first messaging node, a notification for the call request to the second user device;
transmitting, by the second user device, a call acceptance including the second electronic signature to the first messaging node;
verifying, by the first messaging node, whether the call request is from the second user device having the second user DID based on the second electronic signature, and transmitting the endpoint for the call channel to the second user device; and
connecting, by the second user device, to the endpoint for the call channel.

6. The communication method of claim 2, further comprising:
retrieving, by the first user device, available messaging nodes through the blockchain network, and generating a second phone number having a prefix corresponding to the first messaging node among the available messaging nodes;
transmitting, by the first user device, a second phone number registration request to the first messaging node based on the first service endpoint, wherein the second phone number registration request includes the first user DID, the first electronic signature, and type information of the second phone number, and wherein the type information of the second phone number is public;
retrieving, by the first messaging node, the first user status information from the blockchain network based on the first user DID, and generating a first item corresponding to the second phone number in a memory of the first messaging node;
retrieving, by the second user device, available messaging nodes through the blockchain network, and generating a third phone number having a prefix corresponding to a second messaging node among the available messaging nodes;
transmitting, by the second user device, a third phone number registration request to the second messaging node based on a second service endpoint of the second messaging node, wherein the third phone number registration request includes the second user DID, an second electronic signature based on the second user DID, and type information of the third phone number, and wherein the type information of the third phone number is public; and
retrieving, by the second messaging node, the second user status information from the blockchain network based on the second user DID, and generating a second item corresponding to the third phone number in a memory of the second messaging node.

7. The communication method of claim 6, further comprising:
receiving, by the first messaging node, a connection request between the second phone number and the third phone number from the first user device;
generating, by the first messaging node, a storage space between the second phone number and the third phone number connected to the first item;
transmitting, by the first messaging node, the connection request between the second phone number and the third phone number to the second messaging node; and
generating, by the second messaging node, a storage space between the second phone number and the third phone number connected to the second item.

8. The communication method of claim 7, wherein the connection request between the second phone number and the third phone number corresponds to a call connection request from the second phone number to the third phone number generated by the first user device or a message transmission request from the second phone number to the third phone number generated by the first user device.

9. A user device comprising:
a memory storing a user DID; and
at least one processor;
wherein the at least one processor is configured to:
retrieve available messaging nodes through a blockchain network, and generate a first phone number having a prefix corresponding to a first messaging node among the available messaging nodes,
generate a first communication DID corresponding to the first phone number and a first communication private key and a first communication public key corresponding to the first communication DID,
obtain a first service endpoint of the first messaging node from the blockchain network,
transmit a first phone number registration request of a private 1:1 type to the first messaging node based on the first service endpoint, wherein the first phone number registration request includes an electronic signature based on the user DID and the first communication DID,
receive a join notification for the first phone number from a second user device, wherein the join notification includes a second communication DID generated by the second user device,
generate an encryption key based on the second communication DID and the first communication private key, and
transmit an encrypted message with the encryption key to the first messaging node based on the encryption key.

10. The user device of claim 9, wherein the at least one processor is further configured to:
transmit a call request with the second user device based on the first phone number to the first messaging node,
receive an endpoint for a call channel for transmitting media data of the call request and an access token of the call channel from the first messaging node, and
connect to the endpoint for the call channel based on the access token.

11. The user device of claim 10, wherein the at least one processor is further configured to:
encrypt voice data obtained from a user of the user device based on the encryption key, and
transmit the encrypted voice data to the second user device via the call channel.
